(19) United States
(12) Patent Application Publication
(10) Pub. No.: US 2006/0145474 A1
(43) Pub. Date: Jul. 6, 2006

(54) Electromagnetic mechanical pulse forming of fluid joints for low-pressure applications

(76) Inventors: Allen Fischer, Creve Coeur, MO (US); David R. Bolser, Florissant, MO (US); Pradip K. Saha, Kent, WA (US); Mark E. Bice, Algona, WA (US); Don E. Norris, SeaTac, WA (US); Matthew J. Berden, Seattle, WA (US); Kirk A. Reinkens, Spokane, WA (US)

Correspondence Address: OSTRAGER CHONG FLAHERTY & BROITMAN PC, 250 PARK AVENUE, SUITE 825, NEW YORK, NY, 10177, US

(21) Appl. No.: 11/028,093

(22) Filed: Jan. 3, 2005

(51) Int. Cl. F16L 33/00

(52) U.S. Cl. 285/256

(57) ABSTRACT

An electromagnetically formed fluid circuit joint (276) includes a hollow fitting (272) and a tubular conduit (274). The hollow fitting (272) has an outer surface (280) with a groove (278). The tubular conduit (274) is received over the hollow fitting (272). The tubular conduit (274) includes a fitting overlay section (284), a first wall deformation for extension of the fitting overlay section (284) over the hollow fitting (272), and an electromagnetic field formed wall deformation (291) that extends into the groove (278). Another electromagnetically formed fluid circuit joint (642) includes a hollow fitting (654) and a tubular conduit (648). The hollow fitting (654) has an inner surface (668) with a groove (666). The tubular conduit (648) is mechanically separate from and is received within the hollow fitting (654). The tubular conduit (648) includes an externally applied electromagnetic field formed wall deformation (667) that extends into the groove (666).

### RELATED APPLICATION

The present invention is related to U.S. Patent Application (Attorney Docket Numbers 03-0722) entitled “Magnetic Field Concentrator for Electromagnetic Forming and Magnetic Pulse Welding of Fluid Joints”, U.S. Patent Application (Attorney Docket Number 03-1335) entitled “Electromagnetic Pulse Welding of Fluid Joints”, and U.S. Patent Application (Attorney Docket Number 04-0791) entitled “Electromagnetic Mechanical Pulse Forming of Fluid Joints for High-Pressure Applications”, which are incorporated by reference herein.

### TECHNICAL FIELD

The present invention generally relates to the solid state coupling of metallic tubes and fittings. More specifically, the present invention is related to the mechanical magnetic coupling of the tubes to the fittings.

### BACKGROUND ART

Metallic tubes are commonly used to carry fluid in the form of gas or fluid throughout various fluid circuits in many industries. This is especially true in the aerospace industry, due to the lightweight and strong mechanical features of the metallic tubes. For example, thin-walled aluminum and stainless steel tubing is often utilized within an aircraft to carry oxygen and hydraulic fluid for various applications, such as to breathing apparatuses and to and from vehicle brakes.

The fluid circuits typically contain a vast number of interlock joints, which reside between the tubing and the end fittings. The current technique used to join the different sized tubes and fittings, is referred to as a roller swaging process. During this process, a tube is inserted into a fitting while the fitting is constrained using a clamp. The tube is then expanded into the fitting using a roller. The inner walls of the fitting typically contain grooves within which the tube is expanded. An interlock is created between the tube and the fitting due to the expansion and deformation of the tube against the inner walls and into the grooves of the fitting.

Another technique that is commonly used to join metallic tubes to end fittings is referred to as Gas Tungsten Arc Welding (GTAW), which is a fusion welding process. The formed joints produced from fusion welding are sometimes rejected by penetrant inspection, by pressure testing, or by radiographic inspection and must be weld repaired. A weld formed joint may need to be repaired as many as three times, at significant costs.

A desire exists to increase the operating lifetime of a mechanical or fluid tight joint. Thus, there exists a need for an improved leak tight joint between a tube and a fitting and a technique for forming the leak tight joint that may be applied to various fluid circuit applications. It is desirable that the improved technique be economical, have an associated quick production set-up time, and account for different sized tube and fitting combinations.

### SUMMARY OF THE INVENTION

The present invention satisfies the above-stated desires and provides a leak tight joint for low-pressure applications utilizing electromagnetic interactions.

One embodiment of the present invention provides an electromagnetically formed fluid circuit joint that also includes a hollow fitting and a tubular conduit. The hollow fitting has an outer surface with a groove. The tubular conduit is received over the hollow fitting and includes a fitting overlay section, an extended wall deformation, and an electromagnetic field formed wall deformation. The extended wall deformation allows for the extension of the fitting overlay section over the hollow fitting. The electromagnetic field formed wall deformation extends into the groove.

Another embodiment of the present invention provides an electromagnetically formed fluid circuit joint that includes a hollow fitting and a tubular conduit. The hollow fitting has an inner surface with a groove. The tubular conduit is mechanically separate from and is received within the hollow fitting. The tubular conduit includes an externally applied electromagnetic field formed wall deformation that extends into the groove.

The embodiments of the present invention provide several advantages. One such advantage is the provision of electromagnetic mechanically joining process for forming a liquid tight joint between a ferrule and a tube that is leak free. This process is quick and economical.

Another advantage provided by an embodiment of the present invention, is the provision of a ferrule or fitting having one or more grooves for deformation therein by a tube wall. The deformation within the grooves provides a leak tight joint.

Furthermore, another advantage provided by the present invention is the provision of multiple ferrule/tube joint techniques, thus providing a liquid tight joint for various applications.

Moreover, the present invention provides joint, forming techniques with improved repeatability, with quick assembly times, that do not require lubrication to form, and that have low associated scrap rates. The scrap rates, as a result of the joint forming techniques, is approximately zero.

Other features, benefits and advantages of the present invention will become apparent from the following description of the invention, when viewed in accordance with the attached drawings and appended claims.

### BRIEF DESCRIPTION OF THE DRAWINGS

FIG. 1 is a block diagrammatic view of an electromagnetic forming system in accordance with an embodiment of the present invention;

FIG. 2A is a cross-sectional side view of a field shaper/nest assembly that may be incorporated into the system of FIG. 1 in accordance with an embodiment of the present invention;

FIG. 2B is a front cross-sectional view of the field shaper/nest assembly of FIG. 2A;

FIG. 2C is a perspective view of the two halves of the field shaper/nest assembly of FIG. 2A;

FIG. 3A is a half-side cross-sectional view of a tube/fitting coupling and associated forming area incorporating a tube/fitting joint prior to magnetic formation using the assembly of FIG. 2A;

FIG. 3B is a half-side cross-sectional view of a tube/fitting coupling and associated forming area incorporating a tube/fitting joint subsequent to magnetic formation using the assembly of FIG. 2A;

FIG. 3C is a side cut-away view of a tube/fitting coupling incorporating a tube/fitting joint subsequent to magnetic formation using the assembly of FIG. 2A;

FIG. 4 is a cross-sectional side view of a sample fluid carrying ferrule in accordance with an embodiment of the present invention;

FIG. 5 is a cross-sectional side view of a sample hydraulic fluid carrying ferrule in accordance with an embodiment of the present invention;

FIG. 6 is a cross-sectional side view of another sample hydraulic fluid carrying ferrule in accordance with another embodiment of the present invention;

FIG. 7 is a first sample method of magnetically forming a fluid joint in accordance with an embodiment of the present invention;

FIG. 8 is a sample induction coil current pulse curve that may be utilized in the sample method embodiment of FIG. 7;

FIG. 9 is a second sample method of magnetically forming a fluid joint in accordance with another embodiment of the present invention;

FIG. 10 is a sample current pulse curve that may be utilized in the sample method embodiment of FIG. 9;

FIG. 11 is a pressure development diagram in accordance with the embodiment of FIG. 9; and

FIG. 12 is a side cut-away view of a tube/fitting coupling incorporating a tube/fitting joint formed using the method of FIG. 9.

### DETAILED DESCRIPTION

In each of the following Figures, the same reference numerals are used to refer to the same components. While the present invention is described with respect to a system for electromagnetically forming a fluid joint and to the joints formed therefrom, the present invention may be adapted for various applications, such as air, gas, liquid, and fluid applications. The present invention may be applied to low-pressure fluid applications, i.e. less than approximately 2500 psi. The present invention may be applied to fluid applications in the aerospace, automotive, railway, and nautical or watercraft industries, as well as to other industries where fluid tight joints are utilized, such as residential or commercial plumbing.

The present invention allows for the electromagnetic formation of fluid tight joints between fittings and tubular conduits having various diameters. The present invention may be applied to applications where the fittings and the tubular conduits have outer diameters of greater than approximately two inches, as well as to applications where the outer diameters are less than or-equal to approximately two inches.

In the following description, various operating parameters and components are described for one constructed embodiment. These specific parameters and components are included as examples and are not meant to be limiting.

Also, in the following description the term “fitting” may refer to a ferrule, a nut, a union, or other fitting known in the art. A fitting may be magnetically formed to a tubular conduit, as is described below.

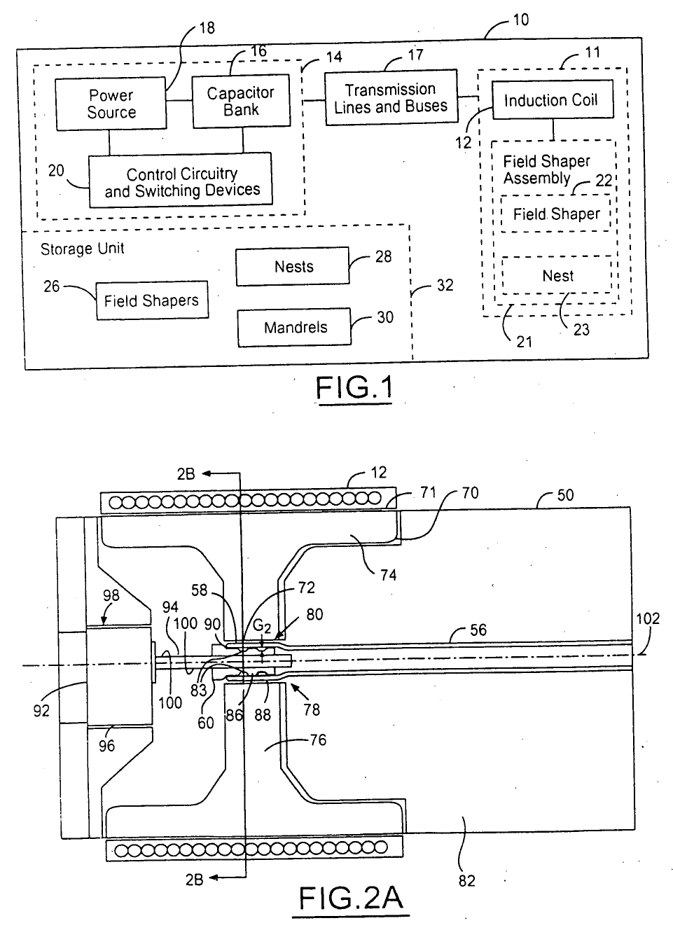

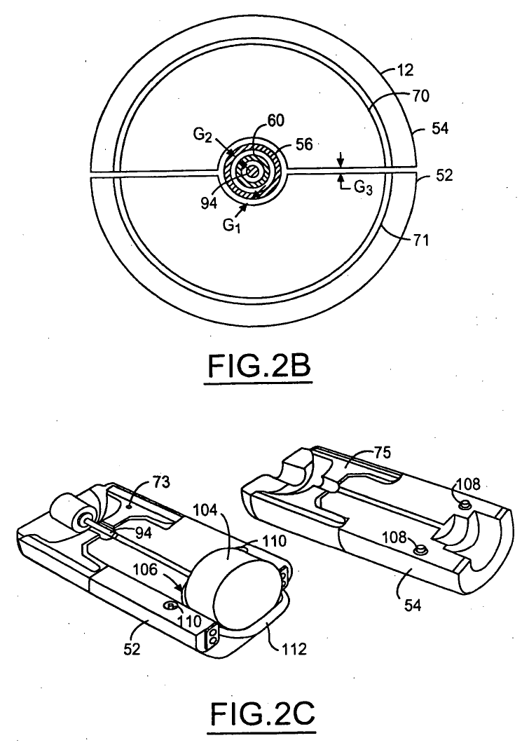

Referring now to FIG. 1, a block diagrammatic view of a magnetic forming system 10 in accordance with an embodiment of the present invention is shown. The magnetic forming system 10 includes induction coil and field shaper assembly 11 with an induction coil 12 that is utilized to magnetically form a fluid joint between fluid carrying tubes and fittings, some examples of fluid joints, fluid carrying tubes, and fittings are shown in FIGS. 2A-6 and 12.

In operation, the induction coil 12 receives current generated from a current supply circuit 14 and generates an electromagnetic field, which is utilized to mechanically form portions of a tube and a corresponding fitting to form a fluid joint. The current supply circuit 14 may include a capacitor bank 16 and a power source 18, as shown. Control circuitry and switching devices 20 are coupled to the capacitor bank 16, via transmission lines and buses 17, and controls charge and discharge thereof via the power source 18. The induction coil 12 may be coupled to a field shaper assembly 21 having a field shaper 22 and nest 23. The field shaper 22 focuses the electrical current within the induction coil 12. Prior to forming a fluid joint, various field shapers 26, nests 28, and mandrels 30, within a storage unit 32, that correspond to a particular tube and fitting combination, are selected. The selected field shaper and nest are fastened within the induction coil 12 prior to electromagnetic forming of a tube and/or a fitting. The fluid joint may be formed without use of the field shaper assembly 21.

The control circuitry may include switches for the setting of various power levels. The control circuitry may be in various forms known in the art and is used to control the power received by the capacitor bank 16 and transmitted to the induction coil 12.

The field shapers 26 are utilized to generate electromagnetic fields to cause the deformation of a tube to form a fluid joint. The field shaper 22 is used to adapt a compression coil, such as the induction coil 12, to a smaller diameter workpiece, having a smaller diameter than the induction coil. The field shaper 22 concentrates the magnetically exerted pressure to a specific location on a tube and/or a fitting. When the capacitor bank 16 is discharged through the induction coil 12, the induced current in the magnetic field produces a magnetic pressure on the conductive tube and/or fitting. The amount of discharged power produces a sufficient amount of magnetic compressive or expansive pressure to conform and deform the tube and/or fitting. The field shapers 26 are generally cylindrical and toroidally shaped. The field shapers 26 may be used to prevent outward expansion of the fittings and the tubes being formed.

The below described embodiment of FIGS. 2A-C, is a sample embodiment that may be utilized in the electromagnetic forming of the walls of a tube to form a fluid tight joint. Other similar embodiments may be utilized.

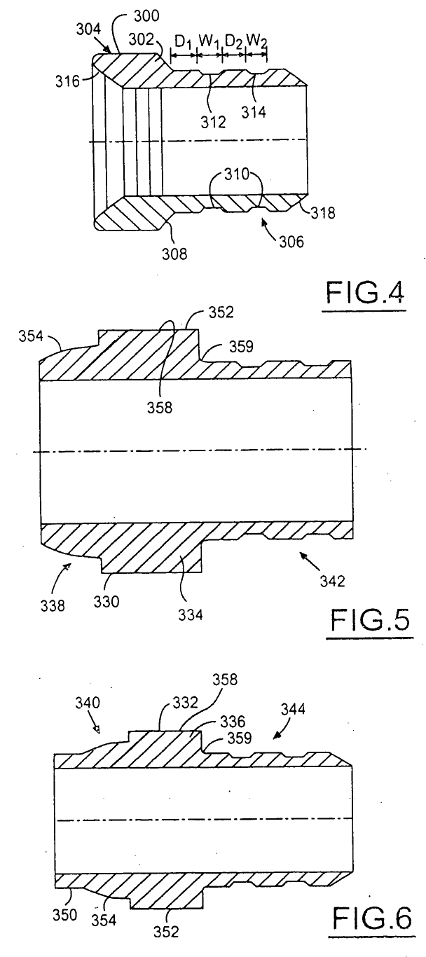

Referring now to FIGS. 2A-C, a cross-sectional side view of an field shaper/nest assembly 50, a front cross-sectional view of the field shaper/nest assembly 50, and a perspective view of the two halves 52 and 54 of the field shaper/nest assembly 50 are shown in accordance with an embodiment of the present invention. A tube 56 having an expanded end 58 is compressed onto a fitting 60. Fitting features are described with respect to the embodiments of FIGS. 4-6 below.

The field shaper/nest assembly 50 utilizes a field shaper 70, which may be one of the field shapers 26, to form a fluid tight joint. The field shaper/nest assembly 50 includes the first half 52 and the second half 54, which is a mirror image of the first half 52. The field shaper 70 is coupled to the induction coil 12. A form or insulation layer 71 may reside between the induction coil 12 and the field shaper 70. The induction coil 12 generates an electromagnetic field, which is imposed on the tube 56 via the field shaper 70. The electromagnetic field accelerates the end 58 toward the fitting 60, thereby compressing the end 58 within the grooves 72 of the fitting 60.

The cross-section of the field shaper 70 is “I”-shaped. The field shaper 70 includes a first shaper half 73 and a second shaper half 75. The combined halves 73 and 75 form an outer ring 74 and a main center disc 76 that extends inward toward a tube/fitting forming region 78. The center disc 76 has a semi-circular opening 80 in the tube/fitting forming region 78. The field shaper halves 73 and 75 are, respectively, connected and have internal dimensions and geometry that correspond with the nest halves 52 and 54. The field shaper 70 is held fixed in place within the nest 82 during electromagnetic forming.

An assembly gap GI resides between the tube 56 and the field shaper 70, which provides clearance for assembly. In one sample embodiment the gap G₁ is approximately 0.03 inches in width. A fly distance gap G₂ resides between the grooves 83 of the fitting 60 and the tube 56, which allows for the acceleration of material portions in the expanded end 58 to be accelerated towards the fitting 60. The size of the fly distance gap G₂ depends upon the depth of the grooves 83. A gap G₃ may also reside between the shaper halves 73 and 75.

The field shaper 70 and the nest 82 are split to provide ease in set-up and disassembling of the field shaper/nest assembly 50. The field shaper 70 may be formed of beryllium copper BeCu or the like. The nest 82 may be of various sizes, shapes, and styles, and may be formed of various non-metallic materials. In one embodiment, the nest 82 is formed of plastic. The nest 82 holds the tube 56 and the fitting 60 in alignment.

The tube 56 and the fitting 60 may be formed of various metallic materials, such as aluminum, stainless steel, and titanium. The fitting 60 includes the grooves 72, in a tube inlay section 86, in which the wall 88 of the tube 56 is deformed therein. This deformation into the grooves 72 provides a non-sealant based fluid tight seal. Although a non-sealant based fluid tight seal may be formed as suggested, sealants known in the art may be utilized, for example, an adhesive may be utilized between the tube 56 and the fitting 60. The end 58 may abut the fitting 60 at the inner step or tube-butting edge 90 of the fitting 60.

The mandrel 92 limits the inward displacement of the tube 56 and the fitting 60. A mandrel 92 resides within the nest 82 and includes an insert portion or stem 94, which is inserted into the tube 56 and the fitting 60 through the tube/fitting forming region 78. The stem 94 is coupled to a handle portion 96, which resides in a recessed portion 98 of the nest 82.

The stem 94 may be slightly tapered, although not shown, and is inserted within the tube 56 and the fitting 60. The outer edges 100 of the stem 94, when tapered, are tapered inward towards the centerline 102 away from the handle portion 96. The mandrel 92 may abut the nest 82 or the fitting 60. The mandrel 92 may be formed of various materials, such as plastic or stainless steel. As an example, the stem 94 may be formed of stainless steel and the handle may be formed of plastic.

A plug 104 may be located within a second recessed portion 106 of the nest 82 and prevent lateral displacement of the tube 56. The nest 82 may include alignment tabs 108 on, for example, the second half 54, and corresponding receivers 110, on the first half 52. The tabs 108 and the receivers 100 ease the alignment and coupling of the first half 52 to the second half 54. A carry handle 112 is shown and may be coupled to the nest 82 for easy insertion and removal from the induction coil 12, and easy carrying and transporting thereof.

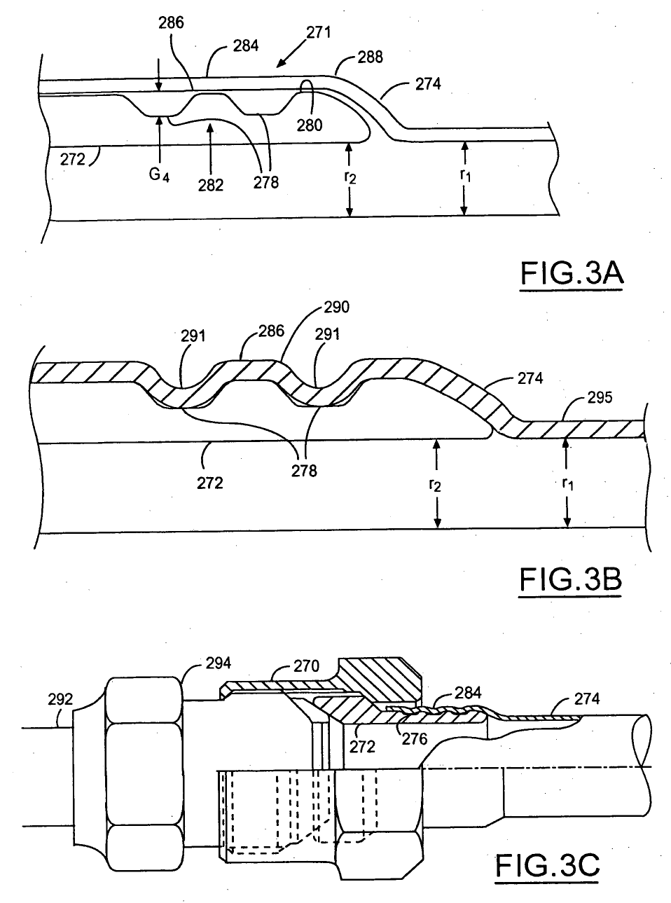

Referring now to FIGS. 3A-C, a half-side cross-sectional view of a tube/fitting coupling 270 and associated forming area 271 is shown prior and subsequent to magnetic formation using the assembly of FIG. 2A, along with a side cut-away view of the tube/fitting coupling 270 subsequent to magnetic formation.

The tube/fitting coupling 270 includes a first tube 292 and a second tube 274. The second tube 274 is coupled to a fitting 272 via a fluid tight joint 276 therebetween. The fitting 272 includes multiple grooves 278 and one or more rib 286 (only one is shown) that are located on an exterior side or surface 280 of the fitting 272 in a tube overlap section or region 282. The tube 274 has a fitting overlay section or an end portion 284 that overlaps the fitting 272. The end portion 284 is expanded prior to being slid over the overlap region 282. A fly distance gap G₄ exists between the grooves 278 and the end portion 284.

In FIG. 3A, the end portion 284 is shown in a first position 288, representing the end portion 284 prior to magnetic forming. In FIG. 3B, the end portion 284 is in a second position 290, representing the end portion 284 subsequent to magnetic forming. During magnetic forming the end portion 284 is formed into the grooves 278. The bent sections of the end portion 284 may be referred to as electromagnetic field formed wall deformations. Two such sections 291 are shown.

In FIG. 3C, the tube/fitting coupling 270 is shown illustrating the union coupling between the first tube 292 and the second tube 274. The tube/fitting coupling 270 includes the first tube 292 and the union 294. The first tube 292 and the union 294 are coupled to the second tube 274 and to the ferrule 272.

Note that the tube internal radius r₁, in the non-expanded portion 295 of the tube 274, is approximately equal in size as the fitting 272 internal radius r₂, as shown in FIG. 3B. Thus, the internal diameters of the fitting 272 and the tube 274 are approximately the same, which allows for a consistent flow of fluid through the tube/fitting coupling 270.

The embodiments of FIGS. 2A-C may be applied to low-pressure fluid applications to form the tube/fitting joint of FIGS. 3B-C. The tube/fitting joint of FIGS. 3B-C when containing thin-walled tubes and/or fittings are capable of withstanding internal fluid pressures of approximately equal to or less than 2500 psi and thus have a fluid pressure rating as such. A “thin-walled” tube refers to one in which the inner diameter of the tube is nearly equal to the outer diameter of the tube. An example of a thin-walled tube is one in which the thickness of the tube wall is less than 0.1 multiplied by the average radius of the tube. Another example of a thin-walled tube is one in which the ratio of the inner diameter to the outer diameter is approximately less than or equal to 1.2.

Referring now to FIG. 4, a cross-sectional side view of a sample fluid-carrying ferrule 300 in accordance with an embodiment of the present invention is shown. The fluid-carrying ferrule 300 includes a wall 302 having a fluid-union coupling region 304 and a tube overlap region 306. A tube end, not shown, may reside over the overlap region 306 and abut the step 308 of the wall 302.

The overlap region 306 includes multiple grooves 310. Although two grooves are shown having a particular shape and size, any number of grooves, having various sizes and shapes may be utilized, depending upon the application. Each groove 310 provides an additional fluid tight transition for additional leak prevention.

In the embodiment shown, the overlap region 306 includes a first groove 312 and a second groove 314. The first groove 312 is slightly wider than the second groove 314. There is approximately equal distance between the step 308 and the first groove 312 as between the first groove 312 and the second groove 314. The widths W₁ and W₂ of the grooves 310 may be approximately equal to the separation distances D₁ and D₂ between the step 308 and the grooves 310.

The ferrule 300 also includes a chamfered inner surface 316 for coupling to a union, such as union 294. The ferrule 300 further includes, within the overlap region 306 a break edge 318, which allows for easy insertion into a tubular conduit.

Referring now to FIGS. 5 and 6, cross-sectional side views of sample hydraulic fluid carrying ferrules 330 and 332 are shown in accordance with an embodiment of the present invention. The hydraulic ferrules 330 and 332 include walls 334 and 336 having hydraulic union coupling regions 338 and 340 and tube overlap regions 342 and 344.

The hydraulic-coupling regions 338 and 340 are different than that of the air-coupling region 304 to accommodate for the different application. The hydraulic-coupling regions 338 and 340 may include a standard wall section 350, steps 352, and arched sections 354. The steps 352 also include radius edges 359 that are associated with an end of a tubular conduit (not

The tube overlap regions 342 and 344 are similar to the tube overlap region 306. The tube overlap regions 342 and 344 may or may not have a break edge.

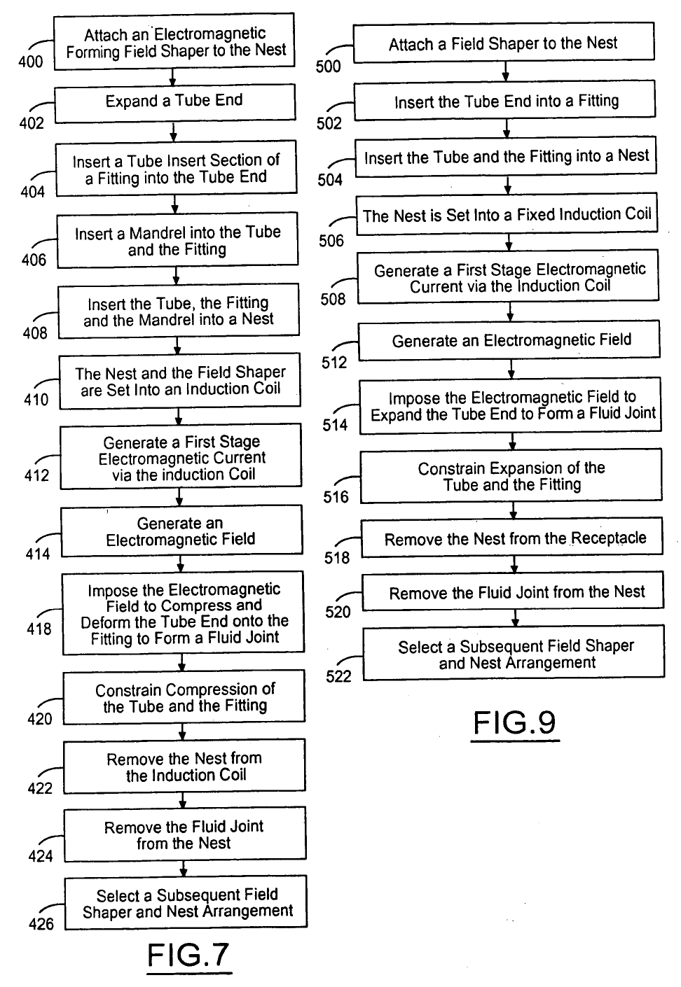

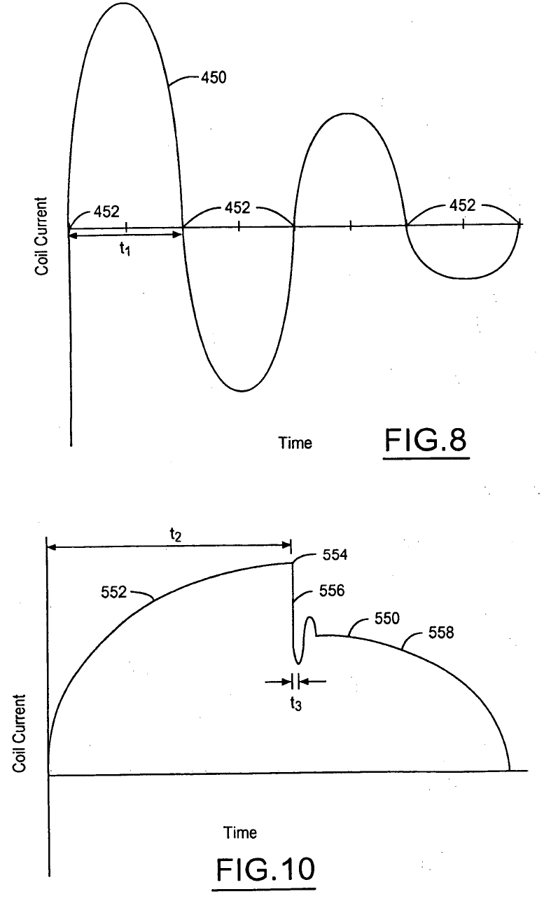

In the methods of FIGS. 7 and 9, the material compositions of the tubes and the fittings utilized can affect the ability of the tubes and or the fittings to be deformed. As an example, to allow deformation of a tube and prevent deformation of a fitting, the material composition of the tube may be adjusted and/or have less tensile strength than that of the fitting to allow for such deformation. The thickness of the tube and fitting walls may also be adjusted to provide various degrees of tensile strength. In addition, the electromagnetic current pulses utilized may also be adjusted to provide the desired deformation in the tube and the fitting. A couple sample current pulses are provided in FIGS. 8 and 10.

Referring now to FIG. 7, a first sample method of magnetically forming a fluid joint in accordance with an embodiment of the present invention is shown.

In step 400, a field shaper, such as one of the field shapers 26 or the field shaper 70, is attached and/or inserted into a current nest, such as the nest 82.

In step 402, a current tube end, such as the tube end 58, is expanded using an end-forming device. In step 404, a current fitting, such as the fitting 60, is inserted into the tube end. In step 406, a mandrel, such as the mandrel 92, is inserted into the tube and the fitting.

In step 408, the tube, the fitting, and the mandrel are inserted into the current nest. The tube, the fitting, and the mandrel are placed on a first half of the nest, such as the first half 52. A second half of the nest, such as the second half 54, is placed over the first half covering and enclosing the fitting, the tube, and the mandrel.

In step 410, the nest or the field shaper assembly is set and may be clamped into an induction coil, such as the induction coil 12.

In step 412, the control circuitry 20, via the capacitor bank and the induction coil, generates a first stage electromagnetic current that is passed into the field shaper via the coupling between the field shaper and the induction coil. A power setting is determined and an electromagnetic current is discharged from the capacitor bank into the induction coil, which is then passed into the field shaper. Various power settings may be used depending on tube and fitting materials, sizes, and thicknesses. In step 414, the field shaper focuses the first stage electromagnetic current to form a concentrated electromagnetic field.

In step 418, the electromagnetic field is imposed upon the exterior of the tube and accelerates and compresses the tube end onto the fitting. In accelerating and compressing the tube onto the fitting, the tube end is deformed into the grooves of the fitting, such as the grooves 72 and 278. The fly distance gaps between the tube and the fitting grooves, such as the gaps G₂, allow for the acceleration of the tube end. The compression and deformation of the tube end forms a pressure tight fluid joint. In step 420, the mandrel constrains or limits the compression of the fitting and the tube during electromagnetic formation. Steps 412-420 are substantially performed simultaneously.

Electrical current from the capacitor bank is passed through the induction coil, which generates an intense electromagnetic field and creates high magnitude eddy currents in the tube end. The opposing magnetic fields that are directly generated by the induction coil and that are generated by the eddy currents accelerate the tube end towards the fitting.

A high current pulse of short duration, approximately between about 10 and 100 microseconds, is introduced to the coils of the induction coil, which generates the electromagnetic field to instantaneously deform the tube radially inward towards the fitting, resulting in the crimping of the tube to the fitting to form the fluid joint. The pulse is strong enough to induce magnetic forces above the yield strength of the material in the tube.

In step 422, upon completion of steps 412-420 the current nest is removed from the induction coil containing the fluid joint. In step 424, the fluid joint is removed from the current nest. The first half and the second half of the current nest are separated to allow for the removal of the fluid joint.

In step 426, prior to returning to step 400, it is determined whether the current setup and configuration of the current tube and the current fitting is to be reused or replaced. It is determined whether to form another tube/fitting coupling using the current field shaper and nest arrangement or to select a replacement field shaper and nest. The replacement field shaper and nest may have different internal dimensions as compared with the current field shaper and nest and may be selected from the field shapers 26 and the nests 28. The different internal dimensions may correspond to a tube/fitting coupling of different size, to a tube/fitting coupling having a different tube/fitting configuration, to a tube/fitting coupling formed using a different electromagnetic forming technique, or to other known tube/fitting related differences known in the art.

The above-described steps in the method of FIG. 7, as well as in the below-described steps in the method of FIG. 9, are meant to be illustrative examples, the steps may be performed synchronously, continuously, or in a different order depending upon the application. Also, some of the steps or portions thereof may not be performed depending upon the application. For example, when a field shaper nest assembly is not utilized, steps 400, 408, 410, 422, 426 or portions thereof may not be performed.

Referring now to FIG. 8, a sample induction coil current pulse curve 450 that may be utilized in the sample method embodiment of FIG. 7 is shown. The pulse curve 450 is one sample current pulse that may be utilized in the method of FIG. 7 when forming the electromagnetic field in step 416. The current passed through the induction coil, such as the induction coil 12, may be pulsed as provided by the pulse curve 450. Of course, other known electromagnetic pulse curves may be utilized. The pulse curve 450 is sinusoidal and decays over time. Approximate duration t, between nulls 452 in the pulse curve 450 is between 30-40 microseconds. The pulse curve 450 is plotted as current magnitude over time.

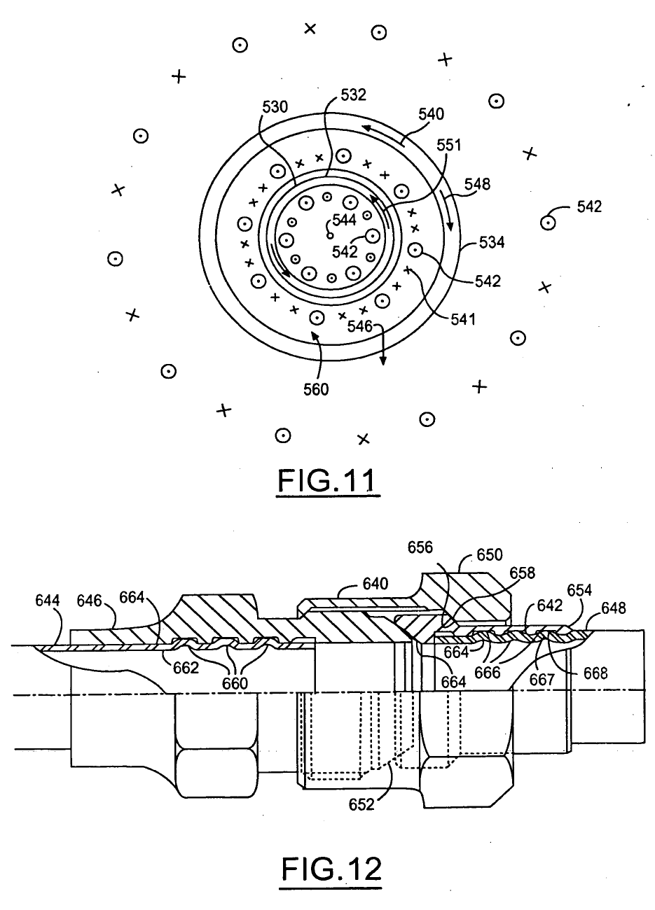

Referring now to FIGS. 9-11, a second sample method of magnetically forming a fluid joint, a sample current pulse curve 550, and a magnetic pressure diagram are shown in accordance with another embodiment of the present invention.

In step 500, a field shaper, such as one of the field shapers 26, is attached and/or inserted into a current nest, such as the nest 82. The field shaper performs as both an electromagnetic forming device and as a constraining device.

In step 502, a current tube, such as the tube 56, is inserted into a current fitting, such as the fitting 60.

In step 504, the tube and the fitting are inserted into the current nest. The tube and the fitting are placed on a first half of the nest. The second half of the nest is placed over the first half covering the tube and the fitting. In step 506, the nest is set into an induction coil, such as the induction coil 12.

In step 508, the control circuitry 20, via a capacitor bank and the induction coil, generates a first stage electromagnetic current that is passed into the field shaper. An electromagnetic current is discharged from the capacitor bank into the induction coil, which is then passed into the field shaper. In step 512, the field shaper focuses the first stage electromagnetic current and forms an electromagnetic field.

The electromagnetic current that is passed into the field shaper may be in the form of a pulse curve or current pulse 550 as shown in FIG. 10. The current pulse 550 is represented by the entire curve of FIG. 10. The shape of the current pulse 550 is such to expand the end of the tube outward towards the induction coil, as opposed to compressing or expanding the tube end away from the induction coil, as performed in the method of FIG. 7. The current pulse 550 is plotted as current magnitude over time.

The first portion 552 of the current pulse 550, during time t₂, allows strong lines of force to be generated both inside and outside of the tube. The frequency of the current pulse 550 does not allow appreciable induced currents to be generated. Induced current within the tube is shown by arrow 551. At the peak 554 of the first portion 552 a second oppositely directed current reduces the current pulse 550 to approximately one half the peak level in time t₃. This opposing fast current pulse effectively cancels the slow current pulse and causes the field to rapidly collapse toward the induction coil producing a strong radial force outward on the tube. The canceling field 541 is shown. This outward force accelerates the tube outward until it conforms to the form of the fitting. The acceleration of the tube outward may also deform the fitting.

The first portion 552, referred to as slow bank current 540, is low enough in frequency not to induce currents in the tubing. The slow bank current 540 generates a solenoidal B-field 542 that surrounds the induction coil. The B-field passes “Out” through the center 544 of the induction coil and “In” from the exterior 546 of the induction coil.

During the second portion 556 of the current pulse 550, referred to as the fast bank current, the opposite current direction in the coil induces a nearly equal and oppositely directed current in the tube. The fields formed from the slow bank current 540 and the fast bank current 548 add together in the region 560 between the tube and the induction coil. The fields are oppositely directed and cancel the field due to the slow bank current 540. The result is a highly differential B-field across the tube wall. The remainder 558 of the current pulse 550 is low enough in frequency and does not affect the forming process.

The force due to the B-field is represented by equation 1.

$${F}_{r} = ( \frac{{B}_{z}}{μ} ) ( \frac{ⅆ {B}_{z}}{ⅆ r} ) = ( \frac{ⅆ}{ⅆ r} ) ( \frac{{B}_{z}^{2}}{2 μ} ) \qquad ( 1 )$$

The magnetic pressure is

$$\frac{{B}_{z}^{2}}{2 μ} .$$

The pressure on the tube P_{tube} is the differential pressure inside and outside of the tube, as represented by equation 2.

$${P}_{tube} = ( \frac{{B}_{z inside}^{2}}{ 2 μ} - \frac{{B}_{z outside}^{2}}{2 μ} ) \qquad ( 2 )$$

As an approximation for the B-field present within the tube a DC calculation is used. The field B_{z} along the axis of a solenoid with a length ten times greater than the radius a can be approximated as represented in equation 3, where N is the number of turns in the induction coil, I is the current, a is the radius of the induction coil, and L is the length of the induction coil.

$${B}_{z} ( {z}_{0} ) = \frac{μ NI}{L} ( 1 - \frac{{a}^{2}}{4 {z}_{0}^{2}} - \frac{{a}^{2}}{4 {( L - {z}_{0} )}^{2}} ) \qquad ( 3 )$$

In a sample embodiment, z₀ is equal to L/2 and L is equal to 10a, thus the field B_{z} may be represented by equation 4.

$${B}_{z} ( {z}_{0} ) = \frac{μ NI}{10 a} \qquad ( 4 )$$

Assuming that the field outside of the tube is reduced to zero the corresponding pressure P on the tube is represented by equation 5.

$$P = ( \frac{{{B}_{z} ( {z}_{0} )}^{2}}{2 μ} ) ( \frac{1}{4.45} ) {( \frac{1}{39.37} )}^{2} \qquad ( 5 )$$

In a sample embodiment with a tube diameter of ⅜ inches, an inside coil diameter of an induction coil of 9/16 inches, the induction coil having 8 turns, and a current pulse peak of 10 kA the resulting B-field is 3.88T, which corresponds to a peak pressure of 867 psi.

In step 514, the electromagnetic field is imposed upon the exterior of the tube and accelerates and expands the tube outward against and to conform to the fitting, as described above. In accelerating and expanding the tube, the tube end may be deformed into the internal grooves of the fitting or the fitting may be deformed into the external grooves of the tube. The expansion of the tube and the deformation of the tube and/or the fitting form a fluid joint. In step 516, the insert, the concentrator, and/or the induction coil constrain or limit the expansion of the fitting and the tube during electromagnetic formation. Steps 508-516 substantially performed simultaneously.

In step 518, upon completion of steps 508-516 the current nest is removed from the concentrator containing the fluid joint. In step 520, the first half and the second half of the current nest are separated to allow for the removal of the fluid joint. The fluid joint is removed from the current nest.

In step 522, it is determined whether the current setup and configuration of the current tube and the current fitting is to be reused or replaced similar to step 426 above. The control circuitry 20 may determine whether to form another tube/fitting coupling using the current field shaper and nest arrangement or to select a replacement field shaper and nest. Upon selection of a second or replacement tube, a second or replacement fitting, a replacement field shaper, step 500 is performed.

Referring now to FIG. 12, a side cut-away view of a tube/fitting coupling 640 is shown, incorporating a tube/fitting fluid joint 642 formed using the method of FIG. 9. The fluid joint 642 is a non-sealant based fluid tight seal, as well as other fluid joints herein described. The tube/fitting coupling 640 includes a first tube 644 having a union 646 residing thereon and a second tube 648 having a nut 650. In connecting the first tube 644 to the second tube 648 the nut 650 is threaded onto the union 646. The tip 652 of the union 646 is pressed into the ferrule 654 due to the coupling between the nut 650 and the ferrule 654 and the threading of the nut 650 onto the union 646. The nut 650 includes a ferrule-chamfered surface 656 that corresponds with a middle tapered exterior surface 658 of the ferrule 654. As the nut 650 is threaded onto the union 646 the nut 650 pulls the union 646 into the ferrule 654.

The union 646 may include grooves 660 on an interior surface 662. A first end 664 of the first tube 644 may be expanded and formed into the grooves 660 using a magnetic forming process as described herein. The ferrule 654 resides between the nut 650 and the union 646 and is coupled to the second tube 648 via a magnetic forming.

The ferrule 654 includes a union chamfered surface 664 in which the tapered tip 652 resides when coupled to the ferrule 654. The ferrule 654 also includes multiple grooves 666 on an interior side 668 for forming of the second tube 648 therein. The second tube 648 includes electromagnetic field formed wall deformations 667 that extend into the grooves 666. The deformations 667 are formed from an externally applied electromagnetic field.

The present invention provides fluid tight leak joints with reduced scrap rate. Further, because the field shaper/nest assemblies are quickly and easily inserted and removed from a fixed structure, a large quantity of tubular joints may be quickly formed. The above stated reduces costs associated with manufacturing down times.

The present invention reduces manufacturing processing steps as compared to conventional welding and roller swaging or elastomeric processes. The present invention also reduces inspection process steps, cost of production, and provides a highly reproducible manufacturing process to maintain consistent quality.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An electromagnetically formed fluid circuit joint comprising:
a hollow fitting having an outer surface with at least one groove; and
a tubular conduit received at least partially over said hollow fitting and comprising:
a fitting overlay section;
a first wall deformation for extension of said fitting overlay section over said hollow fitting; and
an electromagnetic field formed wall deformation extending into said at least one groove.

2. A fluid circuit joint as in claim 1 wherein said hollow fitting and said tubular conduit have a low-pressure maximum fluid rating of approximately 2500 psi.

3. A fluid circuit joint as in claim 1 wherein said hollow fitting and said tubular conduit are formed of at least one material selected from stainless steel, aluminum, and titanium.

4. A fluid circuit joint as in claim 1 wherein said tubular conduit is thin-walled.

5. A fluid circuit joint as in claim 4 wherein said tubular conduit has a wall thickness of less than approximately 0.1 multiplied by the average radius of said tubular conduit.

6. A fluid circuit joint as in claim 1 wherein said electromagnetic field formed wall deformation forms a non-sealant based fluid tight seal with said outer surface.

7. A fluid circuit joint as in claim 1 wherein said hollow fitting comprises:
a tube overlap region comprising;
a radius edge associated with an end of the tube;
least partially into said plurality of grooves; and
a break edge guiding insertion of the fitting into the tube.

8. A fluid circuit joint as in claim 1 wherein said tubular conduit comprises an outer diameter of less than or equal to approximately one inch.

9. A fluid circuit joint as in claim 1 wherein said tubular conduit comprises a first inner diameter and said hollow fitting comprises a second inner diameter that is approximately equal in size as said first inner diameter.

10. A fluid circuit joint as in claim 9 wherein said first inner diameter corresponds with a non-expanded portion of said tubular conduit.

11. A electromagnetically formed fluid circuit joint comprising:
a hollow fitting having an inner surface with at least one groove; and
a tubular conduit mechanically separate from and received at least partially within said hollow fitting, said tubular conduit comprising an externally applied electromagnetic field formed wall deformation extending into said at least one groove.

12. A fluid circuit joint as in claim 11 wherein said externally applied electromagnetic field formed wall deformation forms a non-sealant based fluid tight seal with said inner surface.

13. A fluid circuit joint as in claim 11 wherein the fitting comprises:
a tube inlay section comprising;
a tube butting edge associated with an end of said tubular conduit; and
a plurality of internal grooves, said electromagnetic field formed wall deformation extending into said plurality of internal grooves.

14. A magnetic forming system for creating a fluid circuit joint between a tube and a fitting comprising:
an end former expanding a first portion of the tube;
an induction coil forming an electromagnetic field; and
a nest configured to contain the fitting at least partially positioned within said first portion;
said induction coil imposing said electromagnetic field on the tube to form the fluid circuit joint.

15. A system as in claim 14 further comprising a field shaper residing at least partially within said induction coil, said field shaper focusing and imposing said electromagnetic field on the tube to form the fluid circuit joint.

16. A system as in claim 15 wherein said field shaper resides at least partially within said nest.

17. A system as in claim 15 wherein said field shaper comprises:
an outer ring that is electrically coupled to said induction coil; and
a center member that extends inward and comprises a tube/fitting opening which the tube and the fitting reside.

18. A system as in claim 15 wherein cross-section of said field shaper is “I”-shaped.

19. A system as in claim 15 further comprising an insulation layer between said induction coil and said field shaper.

20. A system as in claim 14 wherein said induction coil imposes said electromagnetic field to compress said first portion on the fitting to form the fluid circuit joint.

21. A system as in claim 14 wherein the fitting comprises a tube overlap region having at least one groove, said electromagnetic field compressing said portion at least partially into said at least one groove.

22. A system as in claim 14 wherein the fitting comprises:
a tube overlap region comprising;
a radius edge associated with an end of the tube;
a plurality of grooves, said electromagnetic field compressing said portion at least partially into said plurality of grooves; and
a break edge guiding insertion of the fitting into the tube.

23. A system as in claim 14 wherein the tube comprises a second portion having a first inner diameter and the fitting comprises a second inner diameter that is approximately equal in size as said first inner diameter.

24. A system as in claim 14 further comprising a mandrel inwardly constraining the tube and the fitting.

25. A system as in claim 14 further comprising:
control circuitry generating a current pulse signal; and
a current supply circuit generating a current pulse in response to said current pulse signal;
said induction coil generating said electromagnetic field in response to said current pulse.
